(19) United States
(12) Patent Application Publication
(10) Pub. No.: US 2007/0162262 A1
(43) Pub. Date: Jul. 12, 2007

(54) Multiplexor approximation method for quantum compilers

(76) Inventor: Robert R. Tucci, Bedford, MA (US)

Correspondence Address: Robert R. Tucci, P.O. Box 226, Bedford, MA, 01730, US

(21) Appl. No.: 11/299,397

(22) Filed: Dec. 8, 2005

(51) Int. Cl. G06F 17/50

(52) U.S. Cl. 703/1

(57) ABSTRACT

A quantum compiler is a software program that runs on a classical computer. It can decompose (“compile”) an arbitrary unitary matrix into a sequence of elementary operations (SEO) that a quantum computer can follow. A quantum compiler previously invented by Tucci decomposes an arbitrary unitary matrix Uᵢₙ into a sequence of U(2)-multiplexors, each of which is then decomposed into a SEO. A preferred embodiment of this invention is a subroutine within a quantum compiler program. The subroutine approximates some or all of the intermediate U(2)-multiplexors whose product equals Uᵢₙ.

### CROSS REFERENCES TO RELATED APPLICATIONS

Not Applicable

### STATEMENT REGARDING FEDERALLY SPONSORED RESEARCH AND DEVELOPMENT

Not Applicable

### BACKGROUND OF THE INVENTION

(A) Field of the Invention

The invention relates to an array of quantum bits (qubits) commonly known as a quantum computer. More specifically, it relates to methods for translating an input data-set into a sequence of operations according to which such an array can be manipulated.

(B) Description of Related Art

This invention deals with Quantum Computing. A quantum computer is an array of quantum bits (qubits) together with some hardware for manipulating these qubits. Quantum computers with several hundred qubits have not been built yet. However, once they are built, it is expected that they will perform certain calculations much faster that classical computers. A quantum computer can be made to follow a sequence of elementary operations. The operations are elementary in the sense that they act on only a few qubits (usually 1, 2 or 3) at a time. For example, CNOTs and one-qubit rotations are elementary operations. (A CNOT is a special type of operation that spans two qubits: a control bit and a target bit. The control bit is often called just the control and the target bit just the target.) Henceforth, we will sometimes refer to sequences as products and to operations as operators, instructions, steps or gates. Furthermore, we will abbreviate the phrase “sequence of elementary operations” by “SEO”. SEOs are often represented as qubit circuits. For a detailed discussion of quantum computing, see NieChu00 [M. Nielsen, I. Chuang, Quantum Computation and Quantum Information, (Cambridge University Press, 2000)]. Also, one can find at www.arxiv.org some excellent, more recent, free introductions to quantum computing.

We will use the term quantum compiling algorithm to refer to an algorithm that can decompose (“compile”) an arbitrary unitary matrix into a SEO, which can then be used to operate a quantum computer. We will use the term quantum compiler to refer to a software program that runs on a classical computer and implements a quantum compiling algorithm (It may do more than this). An early type of quantum compiling algorithm is discussed in Bar95[A. Barenco et al, “Elementary Gates for Quantum Computation”, quant-ph/9503016]. A different type of quantum compiling algorithm was invented by Tucci and is discussed in QbtrPat [U.S. Pat. No. 6,456,994 B1, by R. R. Tucci] , Tuc99 [R. R. Tucci, “A Rudimentary Quantum Compiler (2cnd Ed.)”, quant-ph/9902062], Tuc04Nov [R. R. Tucci, “Qubiter Algorithm Modification, Expressing Unstructured Unitary Matrices with Fewer CNOTs”, quant-ph/0411027], and Tuc04Dec [R. R. Tucci, “Quantum Compiling with Approximation of Multiplexors”, quant-ph/0412072]. Tucci has also written a quantum compiler program called Qubiter that implements the ideas of QbtrPat.

A U(2)-multiplexor will be defined precisely later in this document. The quantum compiling algorithm of QbtrPat and related work decomposes an arbitrary unitary matrix into a sequence of U(2)-multiplexors, each of which is then decomposed into a SEO. (Although QbtrPat uses U(2)-multiplexors, it does not refer to them by this name, which is of more recent vintage.) After QbtrPat was issued, other workers (see Mich04 [V. V. Shende, S. S. Bullock, I. L. Markov, “A Practical Top-down Approach to Quantum Circuit Synthesis”, quant-ph/0406176] and Hels04 [V. Bergholm, J. Vartiainen, M. Mottonen, M. Salomaa, “Quantum circuit for a direct sum of two-dimensional unitary operators”, quant-ph/0410066]) have proposed alternative quantum compiling algorithms that also generate U(2)-multiplexors as an intermediate step.

One measure of the inefficiency of a quantum compiler is the number of CNOTs it uses to express an unstructured unitary matrix (i.e., a unitary matrix with no special symmetries). Call this number N_{CNOT}. Although good quantum compilers must also deal with structured matrices, unstructured matrices are certainly an important case worthy of attention. Minimizing N_{CNOT} is a reasonable goal, since a CNOT operation (or any multi-qubit operation) is expected to take more time to perform and to introduce more environmental noise into the quantum computer, than a one-qubit rotation. Mich03 [V. V. Shende, I. L. Markov, S. S. Bullock, “On Universal Gate Libraries and Generic Minimal Two-qubit Quantum Circuits”, quant-ph/0308033] proved that for matrices of dimension 2^{N}^{_{B}} (where N_{B}=number of bits), one has N_{CNOT}≧¼(4^{N}^{_{B}}−3N_{B}−1). This lower bound is achieved for N_{B}=2 by the 3 CNOT circuits first proposed in Vidal93 [G. Vidal, C. M. Dawson, “A Universal Quantum Circuit for Two-qubit Transformations with 3 CNOT Gates”, quant-ph/0307177]. It is not known whether this bound can be achieved for N_{B}≧3.

As the table of FIG. 1 illustrates, compiling an unstructured unitary matrix with N_{B}>10 requires more than a million CNOTs. Thus, we desperately need an approximation method whereby, given any unitary matrix Uᵢₙ, we can find another unitary matrix V such that: (1) V approximates Uᵢₙ well, and (2) V is expressible with fewer CNOTs than Uᵢₙ. This patent proposes one such approximation method.

The use of approximation methods in quantum compiling dates back to the earliest papers in the field. For example, Copper94 [Don Coppersmith, “An approximate Fourier transform useful in quantum factoring”, (1994 IBM Internal Report), quant-ph/0201067] and Bar95 contain discussions on this issue. The approximation method claimed herein differs substantially from all previously proposed methods. Unlike previous approximation methods, the method propose herein involves approximating U(2)-multiplexors.

The method proposed herein for approximating Uᵢₙ is to approximate some or all of the intermediate U(2)-multiplexors whose product equals Uᵢₙ. One can approximate a U(2)-multiplexor by another U(2)-multiplexor (the “approximant”) that has fewer controls, and, therefore, is expressible with fewer CNOTs. We will call the reduction in the number of control bits the bit deficit δ_{B}. FIG. 2 is emblematic of our approach. It shows a U(2)-multiplexor with 3 controls being approximated by either a U(2)-multiplexor with 2 controls or one with 1 control.

Tucci has previously published a description of this invention in Tuc04Dec. Tuc04Dec presents some details about this invention that are not included in this specification. Tucci considers Tuc04Dec to be essentially correct and in agreement with this specification, and he wishes Tuc04Dec to be considered a part of this specification.

### BRIEF SUMMARY OF THE INVENTION

A quantum computer is an array of quantum bits (qubits) together with some hardware for manipulating these qubits.

A quantum compiling algorithm is an algorithm for decomposing (“compiling”) an arbitrary unitary matrix into a sequence of elementary operations (SEO), which can then be used to operate a quantum computer. A quantum compiler is a software program that runs on a classical computer and implements a quantum compiling algorithm.

A quantum compiler previously invented by Tucci decomposes an arbitrary unitary matrix Uᵢₙ into a sequence of intermediate U(2)-multiplexors, each of which is then decomposed into a SEO.

A preferred embodiment of this invention is a subroutine within a quantum compiler program. The subroutine approximates some or all of the intermediate U(2)-multiplexors whose product equals Uᵢₙ. The effect of using the subroutine within the quantum compiler is that we obtain a SEO that doesn't equal Uᵢₙ exactly, but has the virtue of containing fewer CNOTs (or some other type of multi-qubit gate) than an exact SEO.

In a preferred embodiment of the invention, the subroutine approximates a U(2)-multiplexor by another U(2)-multiplexor that has fewer controls, and, therefore, is expressible with fewer CNOTs.

### BRIEF DESCRIPTION OF THE DRAWINGS

FIG. 1 shows, for each N_{B}, a lower bound on the number of CNOTs required to express an N_{B}-bit unstructured unitary matrix.

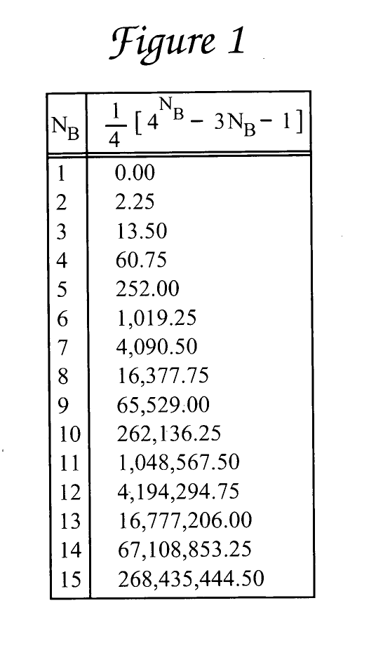

FIG. 2 shows an example of approximating a U(2)-multiplexor by another U(2)-multiplexor with δ_{B} fewer controls.

FIG. 3 shows two diagrammatic representations of a U(2)-multiplexor.

FIG. 4 shows two possible decompositions of an R_{y}(2)-multiplexor with 1 control.

FIG. 5 shows four possible decompositions of an R_{y}(2)-multiplexor with 2 controls.

FIG. 6 shows one of several possible decompositions of an R_{y}(2)-multiplexor with 3 controls.

FIG. 7 shows one of several possible decompositions of an R_{y}(2)-multiplexor with 4 controls.

FIG. 8 shows the first part of an “out_phis.txt” file.

FIG. 9 shows box 91, which is the second part of an “out_phis.txt” file (first part in FIG. 8), and box 92, which is all of an “out_error.txt” file.

FIG. 10 shows a block diagram of a classical computer feeding data to a quantum computer.

### DETAILED DESCRIPTION OF THE INVENTION

### (A) Theory Behind New Method

Notation

First, we will define some notation that is used throughout this patent and in related documents. For additional information about our notation, we recommend that the reader consult Tuc04Dec and Paulinesia[R. R. Tucci, “Q C Paulinesia”, quant-ph/0407215]. Paulinesia is a review article, written by the author of this patent, which uses the same notation as this patent.

Let Bool={0,1}. As usual, let Z, R, C represent the set of integers (negative and non-negative), real numbers, and complex numbers, respectively. For integers a, b such that a≦b, let Z_{a,b}={a,a+1, . . . b−1,b}. For Γ equal to Z or R, let Γ^{>0} and Γ^{≧0} represent the set of positive and non-negative Γ numbers, respectively. For any positive integer r and any set S, let S^{r} denote the Cartesian product of r copies of S; i.e., the set of all r-tuples of elements of S.

For any (not necessarily distinct) objects a₁, a₂, a₃, . . . , let {a₁, a₂, a₃, . . . }_{ord} denote an ordered set. For some object b, let b{a₁, a₂, a₃, . . . }_{ord}={ba₁, ba₂, ba₃, . . . }ord. Let ∅ be the empty set. For an ordered set S, let S^{R} be S in reverse order.

We will use θ(S) to represent the “truth function”; θ(S) equals 1 if statement S is true and 0 if S is false. For example, the Kronecker delta function is defined by δₓ^{y}=δ(x,y )=θ(x=y).

For any positive integer N, we will use \vec{e}ᵢ where i=1, 2, . . . , N to denote the standard basis vectors in N dimensions; i.e., [\vec{e}ᵢ]ⱼ=δ(i,j) for i,j ∈Z_{1,N}.

Iᵣ and 0ᵣ will represent the r-dimensional unit and zero matrices.

For any matrix A and positive integer r, let A^{\hat{x}r} denote the r-fold tensor product of r copies of A. Likewise, let A^{⊕r} denote the r-fold direct sum of r copies of A.

For any matrix A∈C^{r×x} and p=1, 2, ∞, let ∥A∥ₚ represent the p-norm of A, and ∥A∥_{F} its Frobenius norm. See Golub96[G. H. Golub and C. F. Van Loan, Matrix Computations, Third Edition (John Hopkins Univ. Press, 1996)] for a discussion of matrix norms.

Let \vec{x}∈C^{r×1}. As is customary in the Physics literature, ∥\vec{x}∥₂ will also be denoted by |\vec{x}| and called the magnitude of \vec{x}.

The Pauli matrices σₓ, σ_{y}, σ_{z} are defined by

$$\begin{matrix}\begin{matrix}{σ}_{x} = [ \begin{matrix}0 & 1 \\ 1 & 0\end{matrix} ] , & & {σ}_{y} = [ \begin{matrix}0 & - ⅈ \\ ⅈ & 0\end{matrix} ] , & & {σ}_{z} = [ \begin{matrix}1 & 0 \\ 0 & - 1\end{matrix} ] .\end{matrix} & ( 1 ) \\ Let & \\ \vec{σ} = ( {σ}_{x} , {σ}_{y} , {σ}_{z} ) , & ( 2 ) \\ and & \\ {σ}_{a} = \vec{σ} \cdot \vec{a} , & ( 3 ) \\ for any \vec{a} ∈ {ℝ}^{3} . & \\ Define & \\ \begin{matrix}{P}_{0} = [ \begin{matrix}1 & 0 \\ 0 & 0\end{matrix} ] , & & {P}_{1} = [ \begin{matrix}0 & 0 \\ 0 & 1\end{matrix} ] .\end{matrix} & ( 4 )\end{matrix}$$

P₁ is commonly called the number operator, and represented by n, whereas P₀=1−n= n̅. For any b=(b_{N}_{_{B}}₋, . . . , bₗ, b₀)∈Bool^{N}^{_{B}}, let
P_{b}=P_{b}_{_{NB−1}}\textcircled{X}. . . \textcircled{X}P_{b}_{₁}\textcircled{X}P_{b}_{₀} (5)

We will use Ω(β) where Ω is a 2-dimensional matrix such as P₀, σₓ, n, etc., to represent the one-qubit operator Ω acting on qubit β. We will usually represent general qubit labels by lower case Greek letters.

Any x∈R can be expressed as a doubly infinite power series in powers of a base E∈Z^{>0}: x=±Σ_{a=-∞}^{∞}xₐE^{a}. This expansion can be represented by: ±(. . . x₁x₀.x₋₁x₋₂ . . . )_{bE}, which is called the base E representation of x. The plus or minus in these expressions is chosen to agree with the sign of x. It is customary to omit the subscript bE when E=10. For example, 2.25=2+¼=(1.01)_{b2}

Define the action of an overline placed over an a ∈ Bool by 0̅=1 and 1̅=0. Call this operation, bit negation. Define the action of an oplus placed between a, b ∈ Bool by a⊕b=θ(a≠b). Call this operation, bit addition. One can extend the bit negation and bit addition operations so that they can act on non-negative reals. Suppose x=(. . . x₁x₀.x₋₁x₋₂ . . . )_{b2}, and y=(. . . y₁y₀.y₋₁y₋₂ . . . )_{b2} are non-negative real numbers. Then define the action of an overline over x so that it acts on each bit individually; i.e., so that [ x̅]ₐ= x̅ₐ̅. This overline operation is sometimes called bitwise negation. Likewise, define the action of an oplus placed between x and y by (x⊕y)ₐ=xₐ⊕yₐ. This oplus operation is sometimes called bitwise addition (without carry).

We will often use N_{B} to denote a number of bits, and N_{S}=2^{N}^{_{B}} to denote the corresponding number of states. We will use the sets Bool^{N}^{_{B}} and Z_{0,N}_{_{S}}₋₁ inter-changeably, since any x ∈ Z_{0,N}_{_{S}}₋₁ can be identified with its binary representation (x_{N}_{_{B}}₋₁ . . . x₁x₀)_{b2} ∈ Bool^{N}^{_{B}}.

For any =(x_{N}_{_{B}}₋₁ . . . x₁x₀)_{b2} ∈ Z_{0,N}_{_{S}}₋₁, define x^{R}=(x₀x₁ . . . x_{N}_{_{B}}₋₁)_{b2}; i.e., x^{R} is the result of reversing the binary representation of x.

Suppose π: Z_{0,N}_{_{S}}₋₁→Z_{0,N}_{_{S}}₋₁ is a 1−1 onto map. (We use the letter π to remind us that it is a permutation; i.e., a 1−1 onto map from a finite set onto itself). One can define a permutation matrix A with entries given by A_{yx}=θ(y=π(x)) for all x,y ∈ Z_{0,N}_{_{S}}₋₁. (Recall that all permutation matrices A arise from permuting the columns of the unit matrix, and they satisfy A^{T}A=1.) In this patent, we will often represent the map π and its corresponding matrix A by the same symbol π. Whether the function or the matrix is being alluded to will be clear from the context. For example, suppose L is an N_{S} dimension matrix, and π is a permutation on the set Z_{0,N}_{_{S}}₋₁. Then, it is easy to check that for all i,j ∈ Z_{0,N}_{_{S}}₋₁, (π^{τ}L)ᵢⱼ=L_{π(i),j} and (Lπ)ᵢⱼ=L_{i,π(j)}.

Suppose π_{B}: Z_{0,N}_{_{B}}₋₁ →Z_{0,N}_{_{B}}₋₁ is a 1−1 onto map (i.e., a bit permutation). π_{B} can be extended to a map π_{B}: Z_{0,N}_{_{S}}₋₁ →Z_{0,N}_{_{S}}₋₁ as follows. If x=(x_{N}_{_{B}}₋₁ . . . x₁x₀)_{b2} ∈ Z_{0,N}_{_{S}}₋₁; then let [π_{B}(x)]ₐ=x_{π}_{_{B}}_{(α)} for all α ∈ Z_{0,N}_{_{B}}₋₁. The function π_{B}: Z_{0,N}_{_{S}}₋₁→Z_{0,N}_{_{S}}₋₁ is 1−1 onto, so it can be used to define a permutation matrix of the same name. Thus, the symbol π_{B} will be used to refer to 3 different objects: a permutation on the set Z_{0,N}_{_{B}}₋₁, a permutation on the set Z_{0,N}_{_{S}}₋₁, and an N_{S}-dimensional permutation matrix. All permutations on Z_{0,N}_{_{B}}₋₁ generate a permutation on Z_{0,N}_{_{S}}₋₁, but not all permutations on Z_{0,N}_{_{S}}₋₁ have an underlying permutation on Z_{0,N}_{_{B}}₋₁.

An example of a bit permutation that will arise later is π_{R}; it maps π_{R}(i)=i^{R} for all i ∈ Z_{0,N}_{_{S}}₋₁ and π_{R}(α)=N_{B}−1−α for all α ∈ Z_{0,N}_{_{B}}₋₁.

Gray Code

Next, we will review some well known facts about Gray code.

For any positive integer N_{B}, we define a Grayish code to be a list of the elements of Bool^{N}^{_{B}} such that adjacent N_{B}-tuples of the list differ in only one component. In other words, a Grayish code is a 1−1 onto map π_{Gish}: Z_{0,N}_{_{S}}₋₁→Z_{0,N}_{_{S}}₋₁ such that, for all k ∈ Z_{0,N}_{_{S}}₋₂, the binary representations of π_{Gish}(k) and π_{Gish}(k+1) differ in only one component. For any N_{B}>1, there are many functions π_{Gish} that satisfy this definition.

One can define a particular Grayish code that we shall refer to as “the” Gray code and denote by π_{G}. The Gray code can be defined recursively as follows. Let Γ₀=∅. For N_{B}>0, let Γ_{N}_{_{B}} equal the set Bool^{N}^{_{B}} ordered in the Gray code order. In other words, Γ_{N}_{_{B}}={π_{G}(0), π_{G}(1), π_{G}(2), . . . π_{G}(2^{N}^{_{B}}−1)}_{ord}. Then,
Γ_{N}_{_{B}}₊₁={0Γ_{N}_{_{B}}, 1Γ_{N}_{_{B}}^{R}}_{ord} (6)
for N_{B} ∈Z^{≧0}. For example, the Gray code for N_{B}=1 is:
{0,1}_{ord}, (7a)
the Gray code for N_{B}=2 is:
{00,01,11,10}_{ord}, (7b)
the Gray code for N_{B}=3 is:
{000,001,011,010,110,111,101,100}_{ord} (7c)

Suppose π_{B} represents a permutation on Z_{0,N}_{_{B}}₋₁ which generates a permutation on Z_{0,N}_{_{S}}₋₁ of the same name. Clearly, π_{B}∘π_{G} is a Grayish code. Indeed, π_{B}∘π_{G} is a 1−1 onto map, and permuting bits the same way for all elements of a list of Gray code preserves the property that adjacent N_{B}-tuples differ in only one component. (Note, however, that it is easy to find π_{B}'s such that π_{G}∘π_{B} is not a Grayish code. Hence, to preserve Grayishness, one must apply the bit permutation after π_{G}, not before).

Hadamard and Walsh Matrices

Next, we will review some well-known facts about Hadamard and Walsh matrices.

For j ∈ Z_{0,N}_{_{S}}₋₁, define the “reversal” function π_{R(N}_{_{B}}₎(j)=j^{R}, and the “negation” function π_{N(N}_{_{B}}₎(j)= j̅. The function π_{G(N}_{_{B}}₎ for N_{B}-bit Gray code has been defined previously. The functions π_{R(N}_{_{B}}₎, π_{N(N}_{_{B}}₎ and π_{G(N}_{_{B}}₎ are 1−1 onto so they can be used to define permutation matrices of the same name. We will often write π_{R}, π_{N} and π_{G} instead of π_{R(N}_{_{B}}₎, π_{N(N}_{_{B}}₎ and π_{G(N}_{_{B}}₎ in contexts where this does not lead to confusion. Note that π_{R} and π_{N} are symmetric matrices but π_{G} isn't.

For any positive integer N_{B}, we define the N_{B}-bit Hadamard matrix by

$$\begin{matrix}{H}_{1} = \frac{1}{\sqrt{2}} [ \begin{matrix}1 & 1 \\ 1 & - 1\end{matrix} ] , & {H}_{{N}_{B}} = {H}_{1}^{⊗ {N}_{B}}\end{matrix} , \qquad ( 8 )$$

and the N_{B}-bit Walsh matrix by
W_{N}_{_{B}}=H_{N}_{_{B}}π_{R}π_{G} (9)
Eq. (9) implies that the N_{B}-bit Hadamard and Walsh matrices have the same columns, except in different orders. We will often omit the subscript N_{B} from H_{N}_{_{B}} and W_{N}_{_{B}} in contexts where doing this does not lead to confusion. Note that H and W are real symmetric matrices and the square of each of them is one.

The columns of H and W can be conveniently classified according to their constancy (See Tuc04Dec).

Definition of U(2)-Multiplexors

Next, we will define U(2)-multiplexors.

We define a U(2)-subset to be an ordered set {U_{b}: ∀b} of 2-dimensional unitary matrices. Let the index b take values in a set S. In this patent, we are mostly concerned with the case that S=Bool^{N}^{_{B}}⁻¹.

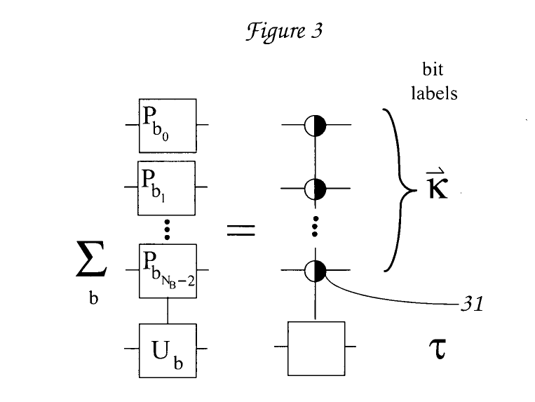

Consider a qubit array with N_{B} qubits labelled 0, 1, . . . , N_{B}−1. Suppose we choose one of these qubits to be the target, and all other qubits to be controls. Let \vec{k}=(k₁, k₂, . . . , k_{N}_{_{B}}₋₁) denote the controls and τ the target. Thus, if τ and \vec{k} are considered as sets, they are disjoint and their union is {0, 1, 2, . . . , N_{B}−1}. Let {U_{b}: ∀b ∈ Bool^{N}^{_{B}}⁻¹} be a U(2)-subset. We will refer to any operator M of the following form as a U(2)-multiplexor:

$$ℳ = {\sum }_{b ∈ {Bool}^{{N}_{B} - 1}} {P}_{b} ( \vec{κ} ) {U}_{b} ( τ ) , \qquad ( 10 )$$

where P_{b}(\vec{k}) acts on the Hilbert space of bits \vec{k} and U_{b}(τ) acts on that of bit τ. Note that M is a function of: the labels \vec{k} of the controls, the label τ of the target, and a U(2)-subset {U_{b}: ∀b ∈ Bool^{N}^{_{B}}⁻¹}. FIG. 3 shows two possible diagrammatic representations of a U(2)-multiplexor. The less explicit representation uses nodes such as 31 that we will call “half moon” nodes.

An example of a U(2)-multiplexor is the direct sum

$$\begin{matrix}ℳ = {\sum }_{b ∈ {Bool}^{{η}_{B}}} {P}_{b} ⊗ {U}_{b} & ( 11 a ) \\ = {U}_{{η}_{S} - 1} ⊕ … ⊕ {U}_{2} ⊕ {U}_{1} ⊕ {U}_{0} , & ( 11 b )\end{matrix}$$

where η_{B}=N_{B}−1, ηₛ=2^{ηB}, and the U_{b} are 2-dimensional unitary matrices. In fact, if we label our qubits so that qubit 0 is the target and 1, 2, 3, . . . N_{B}−1 are the controls, then any U(2)-multiplexor takes the form given by Eq.(11b).

An R_{y}(2)-multiplexor is a U(2)-multiplexor whose U(2)-subset consists solely of one-qubit rotations about the Y axis (i.e., U_{b}=e^{iθ}^{_{b}}^{σ}^{_{y}} for all b).

Decomposition of R_{y}(2)-Multiplexors

Tuc99 and QbtrPat give a method for expressing exactly (“decomposing”) any R_{y}(2)-multiplexor as a SEO consisting of CNOTs and one-qubit rotations. Next, we will present a brief pictorial summary of this decomposition method.

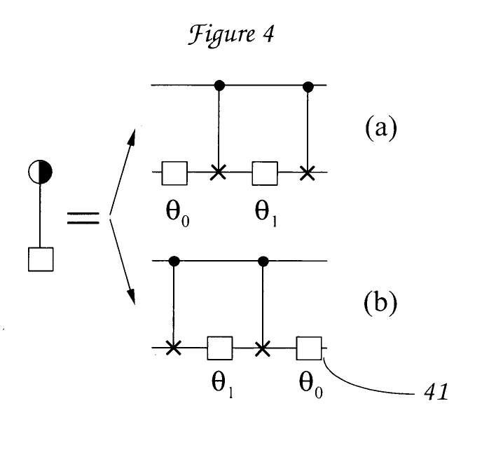

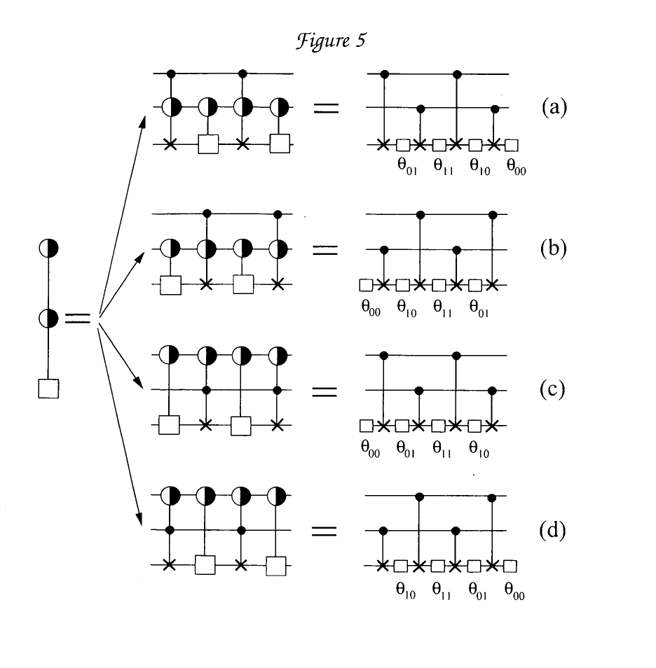

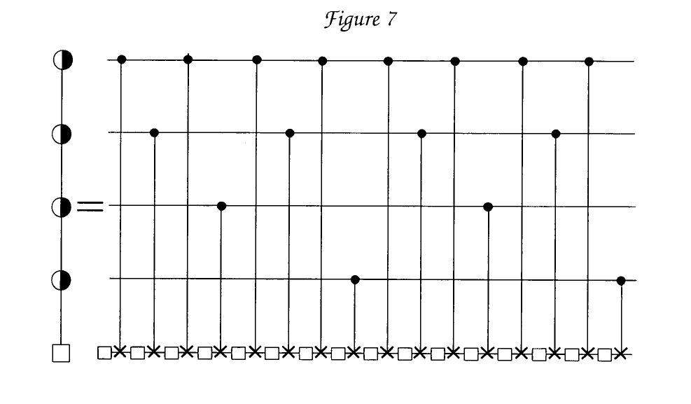

FIGS. 4, 5, 6, and 7 each shows a quantum circuit. Besides the standard circuit symbol for a CNOT, these figures use the following notation. A square gate (such as 41 in FIG. 4) with an angle θ below the square represents exp(iθσ_{y}) applied at that “wire”. FIGS. 4 and 5 each portrays a SEO consisting of alternating one-qubit rotations and CNOTs, with a one-qubit rotation at one end and a CNOT at the other. The angle for the one-qubit rotation that either begins or ends the SEO is denoted by θ_{00 . . . 0}. Given two adjacent angles θ_{b} and θ_{b′} in the SEO₁ (b)b₂ and (b′)_{b2} differ only in one component, component α, where α is the position of the control bit of the CNOT that lies between the θ_{b} and θ_{b′} gates.

FIG. 4 shows two possible ways of decomposing an R_{y}(2)-multiplexor with one control. The decomposition (a) in FIG. 4 is equivalent to:

$$\begin{matrix}exp ( ⅈ {\sum }_{b ∈ Bool} {ϕ}_{b} {σ}_{y} ⊗ {P}_{b} ) = {ⅇ}^{ⅈ {θ}_{0} {σ}_{y} ( 1 )} {{σ}_{x} ( 1 )}^{n ( 0 )} {ⅇ}^{ⅈ {θ}_{1} {σ}_{y} ( 1 )} {{σ}_{x} ( 1 )}^{n ( 0 )} , & ( 12 ) \\ where & \\ [ \begin{matrix}{θ}_{0} \\ {θ}_{1}\end{matrix} ] = \frac{1}{2} [ \begin{matrix}1 & 1 \\ 1 & - 1\end{matrix} ] [ \begin{matrix}{ϕ}_{0} \\ {ϕ}_{1}\end{matrix} ] . & ( 13 )\end{matrix}$$

FIG. 5 shows four possible ways of decomposing an R_{y}(2)-multiplexor with two controls. FIG. 5 was obtained by applying the results of FIG. 4. The decompositions exhibited in FIG. 5 can also be expressed algebraically.

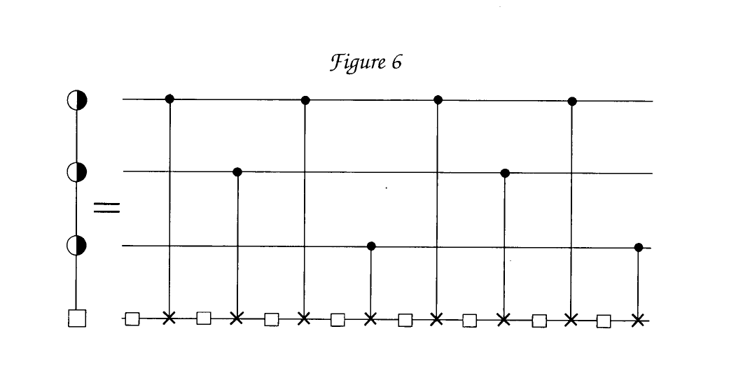

FIG. 6 (respectively, 7) shows one of several possible decompositions of an R_{y}(2)-multiplexor with 3 (respectively, 4) controls. In general, decompositions for multiplexors with N_{K} controls can be obtained starting from decompositions for multiplexors with N_{K}−1 controls.

Approximation of U(2)-Multiplexors

Next we will discuss one possible method for approximating U(2)-multiplexors.

For simplicity, we will first consider how to approximate R_{y}(2)-multiplexors. Later on, we will discuss how to approximate general U(2)-multiplexors.

So far we have used N_{B} to denote a number of bits, and N_{S}=2^{N}^{_{B}} to denote the corresponding number of states. Below, we will use two other numbers of bits, η_{B} and η_{B}′, where η_{B}=N_{B}−1 and η_{B}′≦η_{B}. Their corresponding numbers of states will be denoted by η_{S}=2^{η}^{_{B}} and η_{S}′=2^{η}^{_{B′}}.

Define an η_{S}-dimensional matrix V by
V=Hπ_{B}π_{G}, (14)
where π_{B} is an arbitrary bit permutation on η_{B} bits. Eq.(14) defines a new matrix V by permuting the columns of the Hadamard matrix H. Eq.(14) is a generalization of Eq.(9). In fact, V becomes W if we specialize the bit permutation π_{B} to π_{R}. If we denote the columns of V by \vec{v}ⱼ for j ∈ Z_{0,η}_{_{S}}₋₁, then
\vec{v}ⱼ=\vec{h}_{π}_{_{B}}_{∘π}_{_{G}}₍ⱼ₎ (15)

In Tuc99, the decomposition of an R_{y}(2) multiplexor starts by taking the following Hadamard transform:

$$\vec{θ} = \frac{1}{\sqrt{{η}_{S}}} {H}_{{η}_{B}} \vec{ϕ} , \qquad ( 16 )$$

where η_{B}=N_{B}−1 and η_{S}=2^{η}_{_{B}}. The vectors {\vec{v}ᵢ: ∀i} constitute an orthonormal basis for the space R^{ηS} in which \vec{ø} lives, so \vec{ø} can always be expanded in terms of them:

$$\vec{ϕ} = {\sum }_{i = 0}^{{η}_{S} - 1} {\vec{v}}_{i} ( {\vec{v}}_{i}^{†} \vec{ϕ} ) . \qquad ( 17 )$$

Now suppose that we truncate this expansion, keeping only the first η_{S}′ terms, where η_{S}′=2^{η}^{_{B}}^{′} and η_{B}′ ∈ Z_{0,N}_{_{B}}₋₁. Let us call \vec{φ}′ the resulting approximation to \vec{φ}:

$$\vec{{ϕ}^{′}} = {\sum }_{i = 0}^{{η}_{S}^{′} - 1} {\vec{v}}_{i} ( {\vec{v}}_{i}^{†} \vec{ϕ} ) . \qquad ( 18 )$$

Define \vec{θ}′, an approximation to \vec{θ}, as follows:

$$\vec{{θ}^{′}} = \frac{1}{\sqrt{{η}_{S}}} {H}_{{η}_{B}} \vec{{ϕ}^{′}} \qquad ( 19 )$$

If we let {\vec{e}ᵢ: ∀i} denote the standard basis vectors, then

$$\begin{matrix}{H}_{{η}_{B}} {\vec{v}}_{i} = [ \begin{matrix}{\vec{h}}_{0}^{†} \\ {\vec{h}}_{1}^{†} \\ ⋮\end{matrix} ] {\vec{h}}_{{π}_{B} ∘ {π}_{G} ( i )} = {\vec{e}}_{{π}_{B} ∘ {π}_{G} ( i )} . & ( 20 ) \\ Therefore , & \\ \vec{{θ}^{′}} = \frac{1}{\sqrt{{η}_{S}}} {\sum }_{i = 0}^{{η}_{S}^{′} - 1} {\vec{e}}_{{π}_{B} ∘ {π}_{G} ( i )} ( {\vec{v}}_{i}^{†} \vec{ϕ} ) . & ( 21 )\end{matrix}$$

By virtue of Eq. (21), if we list the components {θ′_{b}: ∀b} of \vec{θ}′ in the Grayish code order specified by the map π_{B} ∘π_{G}, then the items in the list at positions from η_{S}′ to the end of the list are zero. Consider, for example, FIG. 5, which gives the exact decompositions for a multiplexor with 2 controls. Suppose that in one of those decompositions, the angles θ_{b}'s in the second half (i.e., the half that does not contain θ₀₀) of the decomposition are all zero. Then the one-qubit rotations in the second half of the decomposition become the identity. Then the three CNOTs in the second half of the decomposition cancel each other in pairs except for one CNOT that survives. The net effect is that the decomposition for a multiplexor with 2 controls degenerates into a decomposition for a multiplexor with only 1 control. The number of control bits is reduced by one in this example. In general, we can approximate any R_{y}(2)-multiplexor by another R_{y}(2)-multiplexor (the “approximant”) that has fewer controls, and, therefore, is expressible with fewer CNOTs. We will call the reduction in the number of control bits the bit deficit δ_{B}. Hence, δ_{B}=η_{B}−η_{B}′.

The bit permutation π_{B} on which this approximation of a multiplexor depends can be chosen according to various criteria. If we choose π_{B}=π_{R}, then our approximation will keep only the higher constancy components of \vec{φ}. Such a smoothing, high constancies approximation might be useful for some tasks. Similarly, if we choose π_{B}=1, then our approximation will keep only the lower constancy components of \vec{φ}, giving a low constancies approximation. Alternatively, we could use for π_{B} a bit permutation, out of all possible bit permutations on η_{B} bits, that minimizes the distance between the original multiplexor and its approximant. Such a dominant constancies approximation is useful if our goal is to minimize the error incurred by the approximation.

The error incurred by approximating a multiplexor can be bounded above as follows. Let {e^{iφ}_{_{b}}^{σ}_{_{y}}: ∀b ∈ Bool^{ηB}} denote the R_{y}(2)-subset of an R_{y}(2)-multiplexor M_{y} and {e^{iφ′}_{_{b}}^{σ}_{_{y}}: ∀b ∈ Bool^{ηB}} that of its approximant M′_{y}. We will refer to ∥M′_{y}−M_{y}∥₂ as the error of approximating M_{y} by M′_{y}. Tuc04Dec shows that
M′_{y}−M_{y}∥₂≦max/b|φ′_{b}−φ_{b}|=∥\vec{φ}′−\vec{φ}∥_{∞} (22)
We will refer to ∥\vec{φ}′−\vec{φ}∥_{∞} as the linearized error, to distinguish it from the error ∥M′_{y}−M_{y}∥₂.

A simple picture emerges from all this. The number ν of CNOTs (ν could also be taken to be the number of some other type of elementary operation, or else, the number of control bits) that are required to express the multiplexor, and the error ε, are two costs that we would like to minimize. These two costs are fungible to a certain extent. Given a multiplexor M, and an upper bound ε₀ on ε, we can find the approximant M′ with the smallest ν. Similarly, given a multiplexor M, and an upper bound ν₀ on ν, we can find the approximant M′ with the smallest ε.

So far, we have given a method whereby one can approximate any R_{y}(2)-multiplexor M_{y} by another R_{y}(2)-multiplexor M′_{y} so that M′_{y} is expressible with CNOTs than M_{y}. One can extend this approximation method so that is can be used to approximate general U(2)-multiplexors. Here is how. Suppose a general U(2)-multiplexor M can be expressed in the form
M=U_{L}M_{y}U_{R}, (23)
where U_{L} and U_{R} are unitary matrices and M_{y} is an R_{y}(2)-multiplexor. Then one can approximate M by another U(2)-multiplexor M′ given by
M′=U_{L}M′_{y}U_{R}, (24)
where M′_{y} is an R_{y}(2)-multiplexor that approximates M_{y}. M′_{y} can be obtained from M_{y} using the previously described approximation method for R_{y}(2)-multiplexors.

It is always possible to expand a general U(2)-multiplexor M in the form of Eq.(23). Indeed, here are two examples. First example: If we apply the CS decomposition (Golub96) to a general U(2)-multiplexor M, then we get Eq.(23) with
U_{L}=U_{L1}⊕U_{L0}, (25)
U_{R}=U_{R1}⊕U_{R0}, (26)

$${M}_{y} = {\sum }_{b ∈ {Bool}^{N} {B}^{- 1}} {ⅇ}^{{ⅈϕ}_{b} {σ}_{y}} ⊗ {P}_{b} , \qquad ( 27 )$$

where U_{L1}, U_{L0}, U_{R1}, and U_{R0} are unitary matrices. Second Example: In Tuc04Nov, we prove that if a general U(2)-multiplexor M has a U(2)-subset {U_{b}: ∀b ∈ Bool^{N}^{_{B}}⁻¹}, then each U_{b} can be expressed as
U_{b}=e^{iη}^{_{b}}e^{iγ}^{_{b}}^{σ}^{₂}e^{i(α}^{_{b}}^{σ}^{ₛ₁}^{+β}^{_{b}}^{σ}^{ₛ₂}⁾σ_{w}^{f(b)}, (28)
where η_{b}, γ_{b}, α_{b}, β_{b} are real numbers, where (s₁, s₂, w) constitute an orthonormal basis for R³, and where f(b) ∈ Bool (more precisely, f(b)=θ(b_{μ}=1), where μ is a bit position). For each b, one can always find a 2-dimensional unitary matrix V_{b}, a one-qubit rotation about the w axis, such that
V_{b}^{f}e^{i(α}^{_{b}}^{σ}^{ₛ₁}^{+β}^{_{b}}^{σ}^{ₛ₂}⁾V_{b}=e^{iφ}^{_{b}}^{σ}^{_{y}} (29)
Thus, M can be expressed in the form of Eq.(23), with
U_{L}=π^{T}DV^{t} (30)
U_{R}=VCπ, (31)

$${M}_{y} = {\sum }_{b ∈ {Bool}^{N} {B}^{- 1}} {P}_{b} ⊗ {ⅇ}^{{ⅈϕ}_{b} {σ}_{y}} , \qquad ( 32 )$$

where π is a permutation matrix that relabels the qubits so that M becomes a direct sum of 2-dimensional unitary matrices, where D is a diagonal unitary matrix derived from the factors e^{iη}^{_{b}}e^{iγ}^{_{b}}^{σ}^{_{z}}, where C represents a single CNOT, and where V is a direct sum of the V_{b} matrices. In general, there are many ways of expanding a general U(2)-multiplexor M in the form given by Eq.(23), and we do not mean to restrict our method to any particular one.

Note that to calculate the approximant multiplexor M′ defined by Eq. (24), it might not be necessary or advantageous to calculate all the intermediate quantities that we have introduced. Here is an example. To approximate a multiplexor whose U(2)-subset is given by Eq.(28), it is not necessary to calculate the rotations V_{b} explicitly. Instead, one can approximate the parameters α_{b} and β_{b}. Define vectors \vec{α} and \vec{β} from the ordered sets {α_{b}: ∀b} and {β_{b}: ∀b}, respectively. Calculate an approximation \vec{α}′ of \vec{α} using Eq.(18) with φ replaced by α. Likewise, calculate an approximation \vec{β}′ of \vec{β}. The two expansions of \vec{α}′ and \vec{β}′ in the \vec{v}ᵢ basis can be truncated at the same η′_{S}. Now U_{b} can be approximated by replacing α_{b} and β_{b} by α′_{b} and β′_{b}. This procedure avoids calculating the V_{b} but is equivalent to approximating the φ_{b} defined by Eq.(29) by the φ′_{b} defined by Eq.(18).

### (B) Computer Implementation of Theory

Next, we will discuss a simple computer program called “my_moo” that verifies and illustrates many of the results of this patent. “my_moo” is written in the Octave language. Octave is an interactive language and environment. Full source code of “my_moo” is given in as an Appendix to this document.

When you run “my_moo”, Octave produces two output files called “out_phis.txt” and “out_error.txt”.

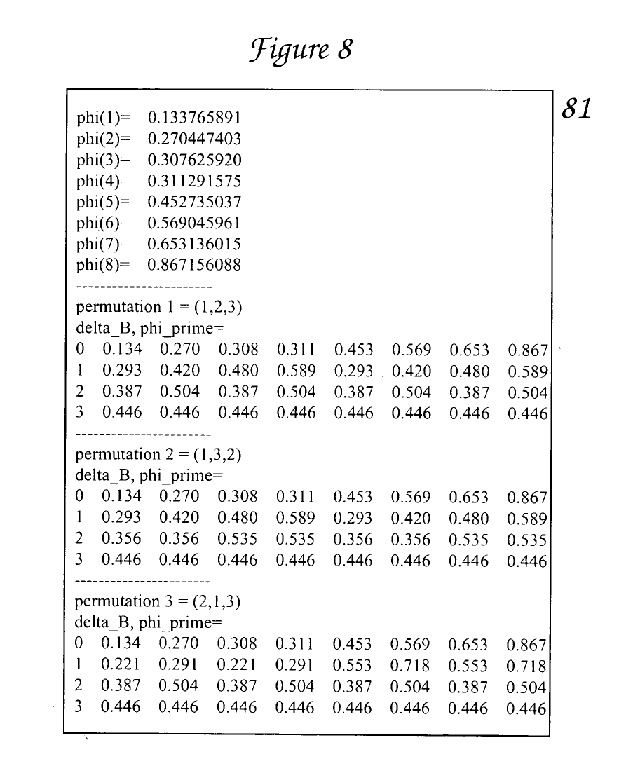

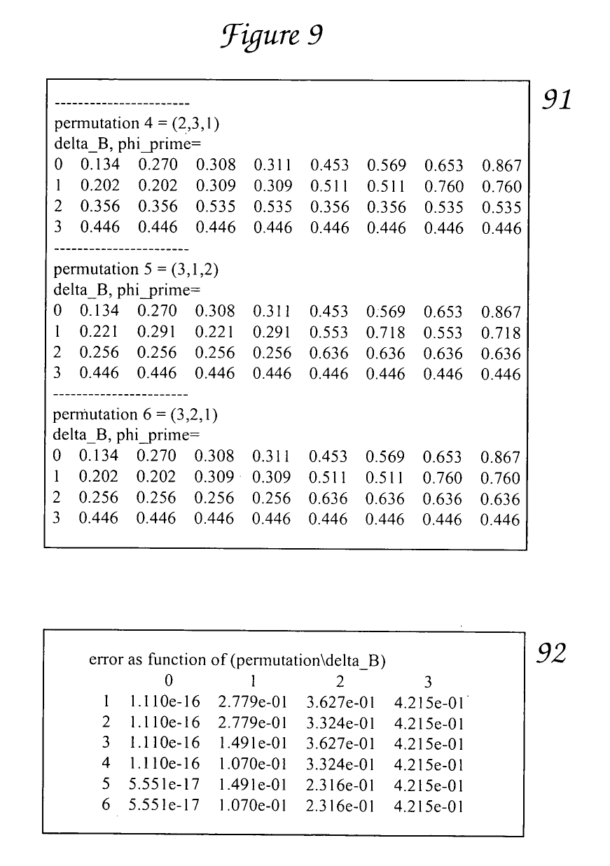

A typical “out_phis.txt” file is shown in FIGS. 8 and 9; it starts with box 81 and ends with box 91. The corresponding “out_error.txt” file is shown in FIG. 9, box 92.

In this example, N_{B}=4 so η_{B}=3 and η_{S}=8. The first 8 lines of “out_phis.txt” give the components of \vec{φ}. In this case, the computer picked 8 independent random numbers from the unit interval, and then it sorted them in non-decreasing order. “my_moo” can be easily modified so as to allow the user himself to supply the components of \vec{φ}.

After listing \vec{φ}, “out_phis.txt” lists the η_{B}! permutations π_{B} of η_{B} bits. For each π_{B}, it prints the components of \vec{φ}′, listed as a row, for each value of δ_{B}(=row label). Note that for δ_{B}=0, \vec{φ}′=\vec{φ}, and for δ_{B}=η_{B}, all φ′ⱼ are equal to the average of all the components of \vec{φ}. Note also that for all values of δ_{B} and j, one has φ′_{j ∈[min}ₖ(φₖ),maxₖ(φₖ)].

The second output file, “out_error.txt”, gives a table of the linearized error ∥\vec{φ}′−\vec{φ}∥_{∞} as a function of permutation number(=row label) and δ_{B}(=column label). As expected, the error is zero when δ_{B} is zero, and it is independent of the permutation π_{B} when δ_{B} is maximum (When the bit deficit δ_{B} is maximum, the approximant has no control bits, so permuting bits at positions Z_{0,η}_{_{B}}₋₁ does not affect the error.)

Note that in the above example, the last permutation minimizes the error for all δ_{B}. This last permutation is π_{B}=π_{R}=(bit-reversal), and it gives a high constancies expansion. Recall that for this example, “my_moo” generated iid (independent, identically distributed) numbers for the components of \vec{φ}, and then it rearranged them in monotonic order. Empirically, one finds that almost every time that “my_moo” is operated in the mode which generates iud numbers for the components of \vec{φ}, the high constancies expansion minimizes the error for all δ_{B}. However, this need not always occur, as the following counterexample shows. Try running “my_moo” for N_{B}=5, and for \vec{φ} with its first 7 components equal to 0 and its 9 subsequent components equal to 1. For this \vec{φ}, and for δ_{B}=3, the high constancies expansion yields an error of ⅞ while some of the other expansions yield errors as low as ⅝.

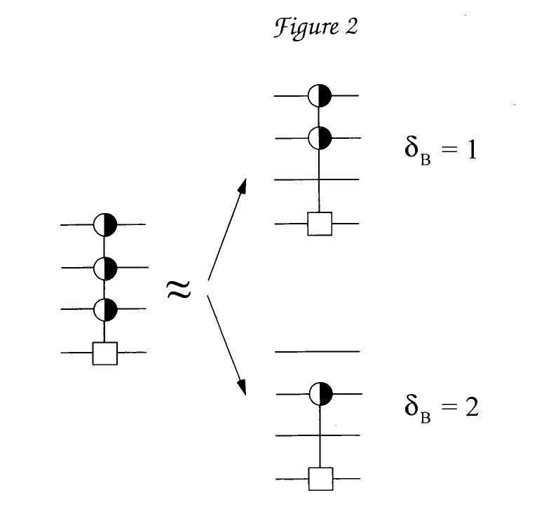

Note that although “my_moo” visits all η_{B}! permutations of the control bits, visiting all permutations is a very inefficient way of finding the minimum error. In fact, the η_{B}! control bit permutations can be grouped into equivalence classes, such that all permutations in a class give the same error. It's clear from FIG. 2 that we only have to visit

$$( \begin{matrix}{η}_{B} \\ {δ}_{B}\end{matrix} ) = \frac{{η}_{B} !}{{δ}_{B} ! {η}_{B}^{′} !} ( where {η}_{B}^{′} = {η}_{B} - {δ}_{B} )$$

equivalence classes of permutations. Whereas η_{B}!≈η_{B}^{η}^{_{B}}=e^{η}^{_{B}}^{lnη}^{_{B}} is exponential in,

$${η}_{B} , ( \begin{matrix}{η}_{B} \\ {δ}_{B}\end{matrix} )$$

is polynomial in η_{B} for two very important extremes. Namely, when δ_{B} or η_{B}′ is of order one whereas η_{B} is very large. Indeed, if δ_{B}=1 or η_{B}′=1, then

$$( \begin{matrix}{η}_{B} \\ {δ}_{B}\end{matrix} ) = {η}_{B} ;$$

if δ_{B}=2 or η_{B}′=2, then

$$( \begin{matrix}{η}_{B} \\ {δ}_{B}\end{matrix} ) = \frac{{η}_{B} ( {η}_{B} - 1 )}{1 \cdot 2} , etc .$$

Those well versed in the art will have no difficulty in writing simple variants of “my_moo”.

Some “my_moo” variants can be written which differ from “my_moo” in how the permutation π_{B} in Eq.(21) is chosen.

In Eq.(21), we sum over all i ∈ S where S=Z_{0,η}_{_{s′}}₋₁ ⊂ Z_{0,η}_{ₛ}₋₁. Other “my_moo” variants could be written if we modify Eq.(21) by changing S to some other subset of Z_{0,η}_{_{S}}₋₁.

Still other “my_moo” variants could approximate a general U(2)-multiplexor M using the method discussed earlier, when we discussed Eqs.(23) and (24).

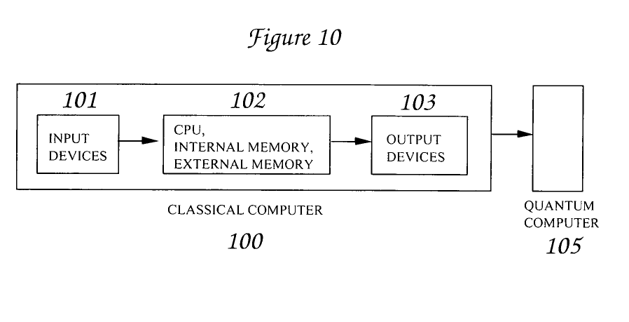

FIG. 10 is a block diagram of a classical computer feeding data to a quantum computer. Box 100 represents a classical computer. It comprises sub-boxes 101, 102, 103. Box 101 represents input devices, such as a mouse or a keyboard. Box 102 represents the CPU, internal and external memory units. Box 102 does calculations and stores information. Box 103 represents output devices, such as a printer or a display screen. Box 105 represents a quantum computer, comprising an array of quantum bits and some hardware for manipulating the state of those qubits. For more information about the organization of a present day classical computer, see CPP [J. Adams, S. Leestma, L. Nyhoff, “C++, an Introduction to Computing”, (Prentice Hall, 1995) pages 19-20.]. A quantum compiler is a software program meant to run inside the classical computer symbolized by box 100.

A “no-frills” preferred embodiment of this invention would be a quantum compiler that would express an input unitary matrix Uᵢₙ as a product of unitary matrices, one of which was an R_{y}(2)-multiplexor M_{y}. The quantum compiler would comprise the approximation subroutine “my_moo”. “my_moo” would be invoked to approximate M_{y} by another R_{y}(2)-multiplexor M′_{y} such that M′_{y} is expressible with fewer CNOTs (or some other type of multi-qubit gate) than M_{y}. There are many variants of this no-frills embodiment which those well versed in the art will be able to derive easily. The no-frills embodiment could be enhanced by using as approximation subroutine (i.e., multiplexor approximator) one of the variants of “my_moo” discussed earlier. Some of these variants of “my_moo” can approximate general U(2)-multiplexors instead of merely R_{y}(2)-multiplexors.

So far, we have described some exemplary preferred embodiments of this invention. Those skilled in the art will be able to come up with many modifications to the given embodiments without departing from the present invention. Thus, the inventor wishes that the scope of this invention be determined by the appended claims and their legal equivalents, rather than by the given embodiments.

APPENDIX
COMPUTER LISTING

%%%%%%%%%%%%%%%%%%%%%%%%%%%%%%%%%%%%
function my_moo
NB=4; %NB=positive integer, number of bits
example =1;
if (NB<1)

error(“NB is less than 1”);

end
len_phi = 2\hat{ }(NB−1);
phi=zeros(len_phi, 1);
switch example

case (1) %phi in increasing order

%rand(“seed”, 1.27);
phi = sort(rand(len_phi,1));

case (2) %phi in decreasing order

%rand(“seed”, 1.27);
phi = flipud(sort(rand(len_phi,1)));

case (3)

if (len_phi !=8)

error(“this example requires NB=4”);

end
phi=[.31; .31;.3100001; .31005; .5;.5;.5; .5];

case (4)

if (len_phi!=16)

error(“this example requires NB=5”);

end
phi=[0;0;0;0;0;0;0;1;1;1;1;1;1;1;1;1];

otherwise

error(“example number is out of range”);

end
max_phi =norm(phi, Inf); % all phi components are non-negative
err_file = fopen (“out_error.txt”, “w”, “native”);
phi_file = fopen (“out_phis.txt”, “w”, “native”);
for i=1:len_phi

fprintf(phi_file, “phi(%d)=\t%11.9f\n”,i, phi(i));

end
fprintf(err_file, “error as function of (permutation\\delta_B)\n”);
for del_B=0:(NB−1 )

fprintf(err_file, “\t%9d”, del_B);

end
fprintf(err_file, “\n”);
more = false;
pi_B = (1: NB−1);
perm_num=0;
while (1)

[ pi_B_new, more_new ] = perm_lex_next ( NB−1, pi_B, more );

if (more_new)

pi_ B = pi_B_new;
more = true;
perm_num++;
fprintf(phi_file, “-----------------------\n”;
fprintf(phi_file, “permutation %d = (”, perm_num);
for i = 1 . NB−2

fprintf (phi_file, “%d,”, pi_B(i) );

end
fprintf (phi_file, “%d)\n”, pi_B(NB−1));
fprintf(phi_file, “delta_B, phi_prime=\n”);
fprintf(err_file, “%4d”, perm_num);
for del_B=0:(NB−1 )

phi_pr = approx_phi(phi, pi_B, del_B, NB);
fprintf(phi_file, “%d”, del_B);
for i=1:len_phi

comp= phi_pr(i);
fprintf(phi_file,“\t%5.3f”, comp);

end
fprintf(phi_file, “\n”);
err= norm(phi - phi_pr, Inf);
fprintf(err_file, “\t%.3e”, err);

end
fprintf(err_file, “\n”);

else

break;

end

end
fclose(err_file);
fclose(phi_file);
%%%%%%%%%%%%%%%%%%%%%%%%%%%%%%%%%%%%
function phi_pr = approx_phi(phi, pi_B, del_B, NB)
if (NB<1)

error(“NB is less than 1”);

end
len_phi = 2\hat{ }(NB−1);
if (length(phi)!=len_phi)

error(“phi has wrong length”);

end
if (length(pi_B)!=NB−1)

error(“pi_B has wrong length”);

end
if (del_B>NB−1|del_B<0)

error(“del_B is out of range”);

end
NS_pr=2\hat{ }(NB−1-del_B);
h = zeros(len_phi, 1);
h_norma = sqrt(len_phi);
phi_pr=zeros(len_phi, 1);
for j=0: (NS_pr−1)

j1 = grayish_code(j, pi_B, NB−1);
for i=0:(len_phi−1)

h(i+1) = (−1)\hat{ }( dec_to_bin(j1, NB−1)*
dec_to_bin(i, NB−1)')./h_norma;

end
phi_pr = phi_pr + h *(h'*phi);

end
%%%%%%%%%%%%%%%%%%%%%%%%%%%%%%%%%%%%
function gish = grayishcode(i, pi_B, NB)
if (NB<1)

error(“NB is less than 1”);

end
if (i>=2\hat{ }NB| i<0)

error(“i is out of range”);

end
if (length(pi_B)!=NB)

error(“pi_B has wrong length”);

end
x=dec_to_bin(i, NB);
y=zeros(1, NB);
for alp=0:(NB−2)

index = NB−alp;
if (x(index−1)==1)

y(index)=1−x(index);

else

y(index)=x(index);

end

end
y(1)=x(1)
z=zeros(1, NB);
for index=1:NB

z(index) = y(pi_B(index));

end
gish = bin_to_dec(z);
%%%%%%%%%%%%%%%%%%%%%%%%%%%%%%%%%%%%
function i = bin_to_dec(x)
NB=length(x);
if (NB<1)

error(“NB is less than 1”);

end
i=0;
for alp=0:(NB−1)

i = i + 2\hat{ }alp*x(NB−alp);

end
%%%%%%%%%%%%%%%%%%%%%%%%%%%%%%%%%%%%
function x = dec_to_bin(i, NB)
if (NB<1)

error(“NB is less than 1”);

end
if (i>=2\hat{ }NB | i<0)

error(“i is out of range”);

end
x=zeros(1, NB);
q=i;
for alp=0:(NB−1)

index = NB−alp;
rem=q−2*floor(q/2); %rem=remainder
q=floor(q/2);
x(index)=rem;

end
%%%%%%%%%%%%%%%%%%%%%%%%%%%%%%%%%%%%
function [ x_new, y_new ] = i_swap ( x, y )
x_new = y;
y_new = x;
%%%%%%%%%%%%%%%%%%%%%%%%%%%%%%%%%%%%
function [ p_new, more_new ] = perm_lex_next ( n, p, more )
%I got this code from the Internet. Bob Tucci
%Reference: Mok-Kong Shen,
%Com. of the ACM, Vol. 6, September 1963, page 517.
more_new = more;
if ( !more_new )

%p_new = (1:n);
p_new = linspace(1,n,n);
more_new = 1;

else

p_new(1:n) = p(1:n);
if ( n <= 1 )

p_new = [ ];
more_new = 0;
return;

end
w = n;
while ( p_new(w) < p_new(w−1) )

if ( w == 2 )

more_new = 0;
return;

end
w = w − 1;

end
u = p_new(w−1);
for j=n:−1:w

if ( u < p_new(j) )

p_new(w−1) = p_new(j);
p_new(j) = u;
ff=floor ( (n − w − 1 ) / 2 );
for k= 0 : ff

[ p_new(n-k), p_new(w+k) ]=i_swap(
p_new(n-k), p_new(w+k));

end
return;

end

end

end

I claim:

1. A method of operating a classical computer, wherein said method must be stored in the external or internal memory units of said classical computer, to calculate a sequence of operations on qubits with the purpose of applying said sequence of operations to a quantum computer to induce said quantum computer to execute a desired calculation, wherein said classical computer comprises a multiplexor approximator, wherein if said multiplexor approximator is given a prior data-set that fairly directly specifies a prior U(2)-multiplexor M, then the approximator will calculate a posterior data-set that fairly directly specifies a posterior U(2)-multiplexor M′, wherein M′ approximates M, wherein M′ can be expressed with fewer elementary operations of a particular type than M, said method comprising the steps of:
storing in said classical computer an initial data-set that fairly directly specifies an U(2)-multiplexor M₁, wherein M₁ is an instance of said M,
applying said multiplexor approximator using as said prior U(2)-multiplexor the multiplexor M₁.

2. The method of claim 1, also utilizing a quantum computer, comprising the additional step of:
manipulating said quantum computer according to said M′ obtained as the output of an application of said multiplexor approximator.

3. The method of claim 1, wherein said elementary operations of a particular type are CNOTs.

4. The method of claim 1, wherein said M′ is chosen by minimization of a measure of the error incurred by approximating said M by said M′, wherein said minimization is subject to a constraint which generally rules out approximating said M by itself.

5. The method of claim 4, wherein said error is defined in terms of ∥M−M′∥, for said M, said M′, and a matrix norm ∥·∥.

6. The method of claim 4, wherein said constraint is an upper bound on the number, used to express said M′, of elementary operations of a particular type.

7. The method of claim 4, wherein said constraint is an upper bound on the number, used to express said M′, of CNOTs.

8. The method of claim 4, wherein said constraint is an upper bound on the number of bits upon which said M′ depends.

9. The method of claim 1, wherein said M′ is chosen by minimization of the number ν of elementary operations of a particular type which are required to express M′, wherein said minimization is subject to an upper bound on a measure of the error incurred by approximating said M by said M′.

10. The method of claim 9, wherein said ν is the number of CNOTs required to express M′.

11. A method of operating a classical computer, wherein said method must be stored in the external or internal memory units of said classical computer, to calculate a sequence of operations on qubits with the purpose of applying said sequence of operations to a quantum computer to induce said quantum computer to execute a desired calculation, wherein said classical computer comprises a multiplexor approximator, wherein if said multiplexor approximator is given a prior data-set that fairly directly specifies a prior U(2)-multiplexor M that is expressible as M=U_{L}M_{y}U_{R}, wherein U_{L} and U_{R} are matrices, wherein M_{y} is an R_{y}(2)-multiplexor, then the approximator will calculate a posterior data-set that fairly directly specifies a posterior U(2)-multiplexor M′ that is expressible as M′=U_{L}M′_{y}U_{R}, wherein M′_{y} is an R_{y}(2)-multiplexor, wherein M′_{y} approximates M_{y}, wherein M′_{y} can be expressed with fewer elementary operations of a particular type than M_{y}, said method comprising the steps of:
storing in said classical computer an initial data-set that fairly directly specifies a U(2)-multiplexor M₁, wherein M₁ is an instance of said M,
applying said multiplexor approximator using as said prior U(2)-multiplexor the multiplexor M₁.

12. The method of claim 11, also utilizing a quantum computer, comprising the additional step of:
manipulating said quantum computer according to said M′ obtained as the output of an application of said multiplexor approximator.

13. The method of claim 11, wherein said elementary operations of a particular type are CNOTs.

14. The method of claim 11, wherein said M′_{y} is chosen by minimization of a measure of the error incurred by approximating said M by said M′, wherein said minimization is subject to a constraint which generally rules out approximating said M by itself.

15. The method of claim 14, wherein said error is defined in terms of ∥M−M′∥, for said M, said M′, and a matrix norm ∥·∥.

16. The method of claim 14, wherein said constraint is an upper bound on the number, used to express said M′_{y}, of elementary operations of a particular type.

17. The method of claim 14, wherein said constraint is an upper bound on the number, used to express said M′_{y}, of CNOTs.

18. The method of claim 14, wherein said constraint is an upper bound on the number of bits upon which said M′_{y} depends.

19. The method of claim 11, wherein said M′_{y} is chosen by minimization of the number ν of elementary operations of a particular type which are required to express M′_{y}, wherein said minimization is subject to an upper bound on a measure of the error incurred by approximating said M by said M′.

20. The method of claim 19, wherein said ν is the number of CNOTs required to express M′_{y}.
